(19) United States
(12) Patent Application Publication
(10) Pub. No.: US 2026/0141232 A1
(43) Pub. Date: May 21, 2026

(54) NEURAL NETWORK FOR INVARIANT CLASSIFICATION AND/OR REGRESSION

(71) Applicant: ROBERT BOSCH GMBH, Stuttgant (DE)

(72) Inventors: Alexandru Paul Condurache, Renningen (DE); Matthias Rath, Stuttgart (DE)

(21) Appl. No.: 18/682,960

(22) PCT Filed: Sep. 23, 2022
(86) PCT No.: PCT/EP2022/076560

§ 371 Date: Feb. 12, 2024

(30) Foreign Application Priority Data
Oct. 4, 2021 (DE) 10 2021 211 143.2

(51) Int. Cl. G06N 3/08

(52) U.S. Cl. CPC G06N 3/08

(57) ABSTRACT

A computer-implemented neural network, The neural network is configured to ascertain an output signal, wherein the output signal characterizes a classification and/or a regression of an image. For the purpose of ascertaining the output signal, the neural network includes a layer which ascertains an output of the layer based on an input of the layer, wherein the input of the layer is based on the image and the output is ascertained based on an invariant integration. An invariant function of the invariant integration includes learnable parameters based on which the output of the layer is ascertained.

### FIELD

The present invention relates to a neural network, a method for ascertaining an output signal, a computer program and a machine-readable storage medium.

### BACKGROUND INFORMATION

Rath and Condurache “Invariant Integration in Deep Convolutional Feature Space”, 2020, https://arxiv.org/pdf/2004.09166.pdf describes a neural network comprising a layer that carries out invariant integration.

### BACKGROUND INFORMATION

Neural networks for image processing are widely used in a variety of fields of technology, for example to control robots and manufacturing machines, or in other automated processes. Special neural networks for image processing, such as convolutional neural networks (CNNs) or visual transformers (also vision transformers) have the advantage that they are equivariant with respect to the position of elements in images; in other words they can ascertain the same results for the same objects, regardless of the position in which a respective object is located.

Extending the property of equivariance with respect to positions of objects in images to other transformations is desirable. For example, it would be desirable for a neural network for image processing to ascertain the same result for the same images that differ from one another only in that they are rotated, for instance. In this respect, Rath and Condurache were already able to demonstrate that invariant integration can be used.

An advantage of a neural network comprising features according to the present invention is that an accuracy of the outputs of the neural network with respect to transformations of a predefinable group, for example the group of all rotations, is significantly improved. The inventors were able to determine that it is particularly advantageous that an invariant function used for an invariant integration can advantageously be exchanged, which makes it possible to increase the accuracy of the output.

### SUMMARY

In a first aspect, the present invention relates to a computer-implemented neural network. According to an example embodiment of the present invention, the neural network is configured to ascertain an output signal, wherein the output signal characterizes a classification and/or a regression of an image, wherein, for the purpose of ascertaining the output signal, the neural network comprises a layer which ascertains an output of the layer based on an input of the layer, wherein the input of the layer is based on the image and the output is ascertained based on an invariant integration, wherein an invariant function of the invariant integration comprises learnable parameters based on which the output of the layer is ascertained.

A computer-implemented neural network can be understood as a neural network that is implemented in a computer, for example in hardware or software, and the computing operations are carried out by the computer.

A neural network can be understood to not be a concatenation of mathematical functions, wherein layers of the neural network characterize the functions. A layer receives an input of the layer and ascertains an output of the layer by processing the input. The input of the layer can be an input of the neural network, for example. Alternatively, it is also possible that the input of the layer is an output of a layer preceding the layer. The neural network can thus build a chain of processing operations, at the beginning of which is the input of the neural network and at the end of which is an output of the neural network. The layers of the chain each contribute to ascertaining the output of the neural network.

According to an example embodiment of the present invention, the neural network disclosed in the first aspect can in particular be configured such that it processes input signals that characterize images. An image characterized by an input signal can in particular be ascertained by an optical sensor, e.g., a camera, a LiDAR sensor, a radar sensor, an ultrasonic sensor or a thermal camera. With respect to the image, the neural network can then ascertain an output signal that characterizes a classification. The output signal can, for instance, comprise indices of one or more classes that the neural network predicts based on the image. Alternatively, it is also possible that the output signal can comprise at least one value that characterizes a probability of a class. Alternatively or in addition to one of the above-described examples, it is also possible that the output signal comprises continuous values, i.e., the neural network carries out a regression analysis based on the input signal.

The layer of the neural network can be understood as an invariant function, i.e., a function that ascertains a same output signal with respect to a group of transformations for an input of the layer if the input of the layer is processed with a transformation of the group. The group can include rotation transformations, for example. The output of the layer would therefore be invariant to rotations of the input of the layer. The layer achieves its property of invariance via an invariant integration carried out by the layer. The invariant integration can be characterized by the formula

$$A [ f ] ( {x}_{in} ) = {\int }_{g ∈ G} f ( {L}_{g} {x}_{in} ) d μ ( g ) ,$$

wherein ƒdμ(g)=1 defines the Haar measure, f is an invariant function, xᵢₙ is the input of the layer and L_{g} is a left operation of the group G. The group G can comprise rotation operations and/or scaling operations as active parts, for example, while the group G includes vectors as passive parts.

According to an example embodiment of the present invention, the invariant integration characterized by the layer advantageously includes an invariant function that comprises at least one learnable parameter. In various preferred embodiments, an integral over the group G is not practically applicable. In these cases, the integral can preferably be replaced by a sum over elements of the group G:

$$A [ f ] ( {x}_{in} ) = \frac{1}{\vert G \vert} {\sum }_{g ∈ G} f ( {L}_{g} {x}_{in} ) .$$

For example, it is possible that the group G characterizes two-dimensional rotations. In this case, it is possible that a finite number of two-dimensional rotations is selected, for example in equidistant steps, and these rotations are used as operations g.

In various example embodiments of the present invention, the invariant function can characterize a multiplication of at least a portion of the layer input by the learnable parameter, for example. This advantageously allows the invariant function to be learned using training data. The invariant function can be adapted to the training data by training, so that the invariant function is specifically adapted to those training data. This increases the prediction accuracy, i.e., the performance, of the neural network.

In various example embodiments of the present invention, it is possible that the invariant function characterizes a weighted sum, for example, in which case weights of summands of the weighted sum are the learnable parameters. The weights can be defined as part of a kernel that is applied to the layer input in a manner similar to a convolution operation, for instance. This procedure can be characterized by the formula

$$A [ WS ] ( x ) = \frac{1}{\vert G \vert \cdot P} {\sum }_{g ∈ G} {\sum }_{p = 1}^{P} {x}_{in} [ l ] ψ ( [ {g}^{- 1} l ]$$

in which WS indicates that a weighted sum is being used as an invariant function, p indexes possible positions of the layer input, P characterizes the total number of possible positions and ψ characterizes a kernel that is being applied at position p according to the inverse operation g⁻¹. For instance, it is possible that the layer input xᵢₙ characterizes a tensor, for example the output of a convolutional layer of the neural network. The tensor can in particular be a three-dimensional tensor, wherein each dimension characterizes a height, width and depth of the tensor. In this case, the tensor can be understood to include feature vectors for pixels of the image or regions of the image, wherein the feature vectors are disposed along the height and width. The kernel can be configured to process all feature vectors and is thus evaluated at only one position p. In this case, P=1. Alternatively, it is also possible that the kernel processes only a specific area along the height and width of the tensor, and is thus applied at multiple positions p. In this case, the positions p can characterize all possible positions of the kernel along the height and width of the tensor.

It is in particular also possible that the invariant function includes one kernel per element along the depth of the tensor. In other words, it is possible that there is one kernel per channel of the tensor.

The inventors were able to determine that the performance of the neural network is improved by using a weighted sum as the invariant function of the invariant integration.

In various further example embodiments of the present invention, it is also possible that the invariant function characterizes a multilayer perceptron.

In these example embodiments of the present invention, the invariant integration can be characterized by the formula

$$A [ MLP ] ( {x}_{in} ) = \frac{1}{\vert G \vert \cdot P} {\sum }_{g ∈ G} {\sum }_{p = 1}^{P} MLP ( {L}_{g}^{- 1} {x}_{in} [ {𝒩}_{p} ] )$$

wherein MLP characterizes a multilayer perceptron, to which at least a portion [symbol] of the layer input xᵢₙ is passed as an input, wherein the portion [symbol] of the layer output is determined based on the position p. For a feature vector at position p along the height and width of the tensor, for instance, the feature vector and the direct neighbors of the feature vectors in the tensor can be passed to the multilayer perceptron as the input.

The multilayer perceptron includes weights that can be adapted during training of the neural network.

The inventors were able to determine that a multilayer perceptron as the invariant function advantageously represents a suitable alternative to the weighted sum to increase the performance of the neural network.

In various other example embodiments of the present inventio, it is possible that the invariant function characterizes a self-attention, in particular a visual self-attention.

In these example embodiments of the present invention, the invariant integration can be characterized by the formula

$$A [ SA ] ( x ) = \frac{1}{\vert G \vert} {\sum }_{g ∈ G} softmax ( {L}_{g} A ) {L}_{g} {x}_{in} {W}_{v}$$

wherein A characterizes an attention matrix, which can be ascertained according to the formula A=xᵢₙW_{g} (xᵢₙWₖ)^{T}, and W_{q}, Wₖ and Wₖ each characterize a matrix that includes learnable parameters.

The matrix A can also be ascertained using relative encoding of the positions of feature vectors in the tensor of the input of the layer. This can, for example, be characterized by the formula

$${A}_{i , j} = {x}_{i} {{W}_{q} ( ( {x}_{j} + {P}_{{x}_{j} - {x}_{i}} ) {W}_{k} )}^{T}$$

wherein xᵢ or xⱼ characterize a feature vector at position i or j of the tensor and Pₓ_{ⱼ}₋ₓ_{ᵢ} is a relative encoding of the feature vectors at position i and position j.

The inventors were able to determine that a self-attention as the invariant function advantageously represents a suitable alternative to the weighted sum to increase the performance of the neural network.

In the various example embodiments of the present invention disclosed herein, it is also possible that the input of the layer is ascertained by a first portion of the neural network, wherein the first portion characterizes an equivariant mapping of the input image to the input of the layer.

The first portion of the neural network can be understood as a backbone of the neural network. In the first portion, features of the image can advantageously be extracted in such a way that the features are equivariant with respect to a group of operations, for example, equivariant with respect to translation and scaling. For this purpose, layers from a neural network known as SESN can preferably be used. The invariant integration can then be ascertained via the group of scalings, for instance. This causes the neural network to become invariant with respect to translation and scaling. The inventors were able to determine that this advantageously makes it possible to further increase the performance of the neural network.

In another aspect, the present invention relates to a computer-implemented method for ascertaining an output signal, wherein the output signal characterizes a classification and/or a regression of an image, wherein the output signal is ascertained using a neural network and based on the image, wherein the neural network is configured according to any one of the above-described embodiments and/or aspects.

The performance of the neural network can thus advantageously be transferred to a method for image analysis.

In various example embodiments of the present invention, it is also possible that a control signal of an actuator and/or a display device is ascertained based on the output signal.

This advantageously makes it possible to better control the actuator or the display device.

In another aspect, the present invention invention relates to a computer-implemented method for training a neural network, wherein the neural network is configured according to any one of the above described embodiments and/or aspects of the present invention.

According to an example embodiment of the present invention, the neural network can be trained using a gradient descent method, for instance. Since the various embodiments of the neural network each use differentiable operations, gradients of the parameters of the neural network can be ascertained using the backpropagation method. Conventional loss functions can be used as the loss function, for example negative log-likelihood functions.

Alternatively, it is also possible that parameters of the neural network are ascertained using a gradient-free optimization method, for example using evolutionary algorithms. In these cases, the accuracy of the neural network can be used as the loss function.

Example embodiments of the present invention are explained in more detail in the following with reference to the figures.

### BRIEF DESCRIPTION OF THE DRAWINGS

FIG. 1 shows schematically, the structure of a neural network, according to an example embodiment of the present invention.

FIG. 2 shows schematically, a structure of a control system for controlling an actuator, according to an example embodiment of the present invention.

FIG. 3 shows schematically, an embodiment example for controlling an at least partially autonomous robot, according to the present invention.

FIG. 4 shows schematically, an embodiment example for controlling a manufacturing system, according to the present invention.

FIG. 5 shows schematically, an embodiment example for controlling an access system, according to the present invention.

FIG. 6 shows schematically, an embodiment example for controlling a monitoring system, according to the present invention.

FIG. 7 shows schematically, an embodiment example for controlling a personal assistant, according to the present invention.

FIG. 8 shows schematically, an embodiment example for controlling a medical imaging system, according to the present invention.

FIG. 9 shows schematically, an embodiment example of a medical analysis device, according to the present invention.

FIG. 10 shows schematically, a training system for training the neural network, according to an example embodiment of the present invention.

### DETAILED DESCRIPTION OF EXAMPLE EMBODIMENTS

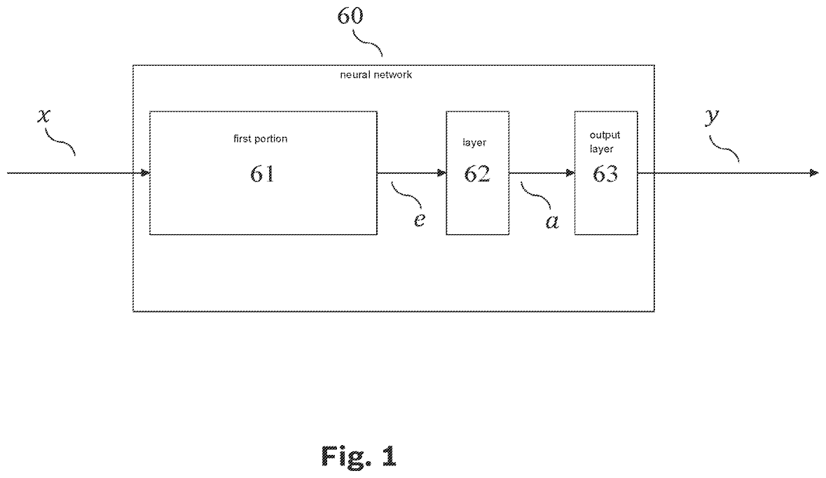

FIG. 1 shows a neural network (60). The neural network (60) receives an input signal (x) which characterizes at least a portion of an image. The neural network (60) processes the input signal (x) and ascertains an output signal (y), wherein the output signal (y) characterizes a classification and/or a regression result, i.e., the result of a regression analysis, of the input signal (x).

To ascertain the output signal (y), the neural network (60) preferably comprises a first portion (61), which can also be understood as the backbone of the neural network (60). The backbone preferably comprises layers that characterize equivariant mappings, e.g., group equivariant convolutions. The layers can be equivariant with respect to translation, scaling and/or rotation, for instance. On the basis of the input signal (x), the first portion (61) ascertains an output that preferably characterizes a three-dimensional tensor. The tensor can in particular characterize a width, height and depth in each dimension. Feature vectors can then be disposed along the height and width dimensions, wherein the feature vectors themselves extend along the depth dimension. The tensor can be used as the input (e) of a layer (62), wherein the layer (62) characterizes an invariant integration. The layer (62) can be understood as a mathematical mapping that maps the input (e) of the layer to an output (a) of the layer, wherein the mapping is invariant. To ascertain the output (a), the invariant integration can use an invariant function comprising learnable parameters. The invariant function can in particular be characterized by a weighted sum, a multilayer perceptron or by a self-attention.

The output (a) ascertained by the layer (62) can then be passed to an output layer (63) of the neural network (60), wherein the output layer (63) can be configured to ascertain the output signal (y) of the neural network (60) based on the output (a). The output signal (y) can characterize a classification, for example a single-label classification and/or a multi-label classification and/or an object detection and/or a semantic segmentation. Alternatively or additionally, it is also possible that the output signal (y) characterizes a result of a regression analysis, e.g., a vector from the set of real numbers.

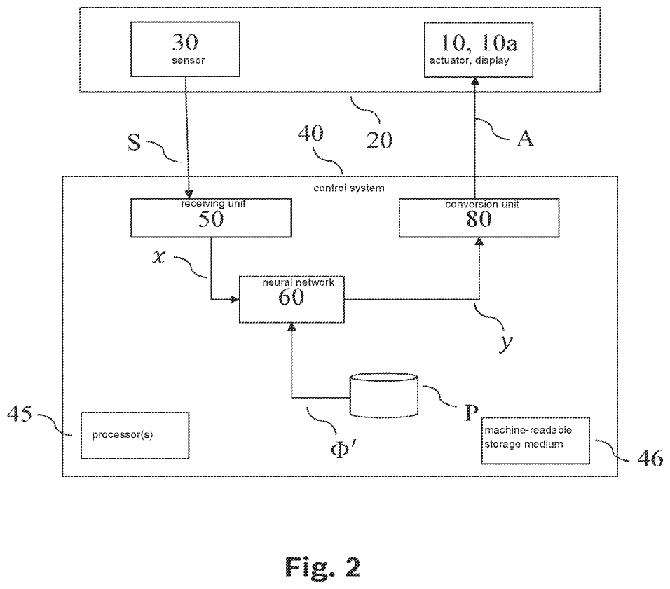

FIG. 2 shows an actuator (10) in its environment (20) in interaction with a control system (40), wherein the control system (40) controls the actuator (10) based on the output signal (y) of the neural network (60). At preferably regular time intervals, the surroundings (20) are sensed in a sensor (30), in particular an imaging sensor, such as a camera sensor, which can also be a plurality of sensors, for example a stereo camera. The sensor signal(S) or, in the case of multiple sensors one respective sensor signal(S), of the sensor (30) is transmitted to the control system (40). The control system (40) thus receives a sequence of sensor signals(S). From these, the control system (40) ascertains control signals (A) which are transmitted to the actuator (10).

The control system (40) receives the sequence of sensor signals(S) of the sensor (30) in an optional receiving unit (50), which converts the sequence of sensor signals(S) into a sequence of input signals (x) (the sensor signal(S) can alternatively also be adopted directly as the input signal (x)). The input signal (x) can be a section or a further processing of the sensor signal(S), for example. In other words, the input signal (x) is ascertained depending on the sensor signal(S). The sequence of input signals (x) is fed to the neural network (60).

The neural network (60) is preferably parameterized by parameters (Φ) which are stored in and provided by a parameter memory (P).

The neural network (60) ascertains output signals (y) from the input signals (x). The output signals (y) are fed to an optional conversion unit (80), which uses them to ascertain control signals (A) that are fed to the actuator (10) to accordingly control the actuator (10).

The actuator (10) receives the control signals (A), is controlled accordingly and carries out a respective action. The actuator (10) can comprise a (not necessarily structurally integrated) control logic which, from the control signal (A), ascertains a second control signal which is then used to control the actuator (10).

In further embodiments, the control system (40) comprises the sensor (30). In still further embodiments, the control system (40) alternatively or additionally also includes the actuator (10).

In further preferred embodiments, the control system (40) comprises at least one processor (45) and at least one machine-readable storage medium (46) on which instructions are stored that, when executed on the at least one processor (45), prompt the control system (40) to carry out the method according to the present invention.

In alternative embodiments, a display unit (10a) is provided as an alternative or in addition to the actuator (10).

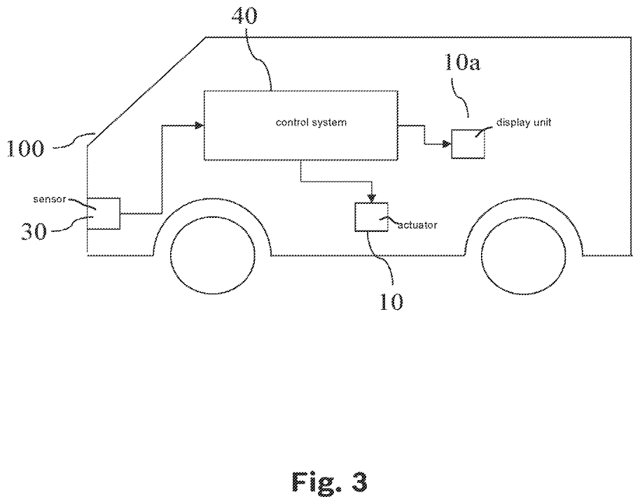

FIG. 3 shows how the control system (40) can be used to control an at least partially autonomous robot, here an at least partially autonomous motor vehicle (100).

The sensor (30) can be a video sensor that is preferably disposed in the motor vehicle (100), for example. In this case, the input signals (x) can be understood as input images.

In this embodiment example, the artificial neural network (60) is configured to identify objects that can be seen in the input images (x).

The actuator (10), which is preferably disposed in the motor vehicle (100), can be a brake, a drive, or a steering of the motor vehicle (100), for example. The control signal (A) can then be ascertained such that the actuator or actuators (10) are controlled in such a way that the motor vehicle (100) prevents a collision with the objects identified by the neural network (60), for example, in particular if they are objects of specific classes, e.g., pedestrians.

Alternatively, or additionally, the control signal (A) can be used to control the display unit (10a) and, for example, display the identified objects. It is also possible that the display unit (10a) is controlled with the control signal (A) such that it outputs an optical or acoustic warning signal when it is ascertained that the motor vehicle (100) is at risk of colliding with one of the identified objects. The warning by means of a warning signal can also be provided with a haptic warning signal, for example via a vibration of a steering wheel of the motor vehicle (100).

The at least partially autonomous robot can alternatively also be another mobile robot (not shown), for example one that moves by flying, swimming, diving, or walking. The mobile robot can also be an at least partially autonomous lawnmower, for instance, or an at least partially autonomous cleaning robot. In these cases too, the control signal (A) can be ascertained such that the drive and/or steering of the mobile robot are controlled in such a way that the at least partially autonomous robot prevents a collision with objects identified by the neural network (60), for example.

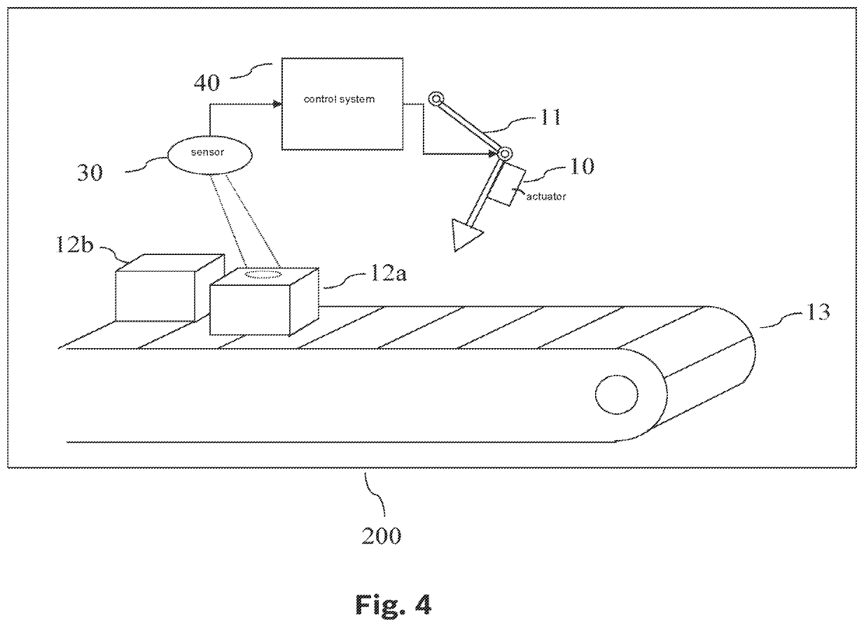

FIG. 4 shows an embodiment example in which the control system (40) is used to control a manufacturing machine (11) of a manufacturing system (200) by controlling an actuator (10) that controls said manufacturing machine (11). The manufacturing machine (11) can, for instance, be a machine for punching, sawing, drilling and/or cutting. It is also possible that the manufacturing machine (11) is configured to grab a manufactured product (12a, 12b) by means of a gripper.

The sensor (30) can then be a video sensor, for example, that senses the conveying surface of a conveyor belt (13), for instance, wherein manufactured products (12a, 12b) can be located on the conveyor belt (13). In this case, the input signals (x) are input images (x). The neural network (60) can, for example, be configured to ascertain a position of the manufactured products (12a, 12b) on the conveyor belt. The actuator (10) controlling the manufacturing machine (11) can then be controlled depending on the ascertained positions of the manufactured products (12a, 12b). The actuator (10) can be controlled such that it punches, saws, drills and/or cuts a manufactured product (12a, 12b) at a predetermined location on the manufactured product (12a, 12b), for instance.

It is also possible that the neural network (60) is configured to ascertain further properties of a manufactured product (12a, 12b) as an alternative or in addition to the position. It is in particular possible that the neural network (60) ascertains whether a manufactured product (12a, 12b) is defective and/or damaged. In this case, the actuator (10) can be controlled such that the manufacturing machine (11) rejects a defective and/or damaged manufactured product (12a, 12b).

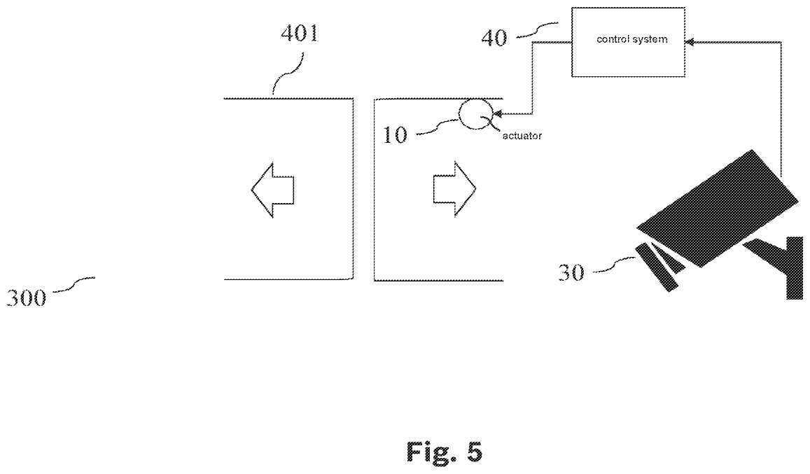

FIG. 5 shows an embodiment example in which the control system (40) is used to control an access system (300). The access system (300) can comprise a physical access control, for example, a door (401). The sensor (30) can in particular be a video sensor or thermal imaging sensor that is configured to sense an area in front of the door (401). An acquired image can be interpreted using the neural network (60). The image classifier (60) can in particular detect people on a transmitted input image (x). If multiple individuals are detected at the same time, the identity of the individuals can be ascertained particularly reliably by associating the individuals (i.e., the objects) with one another, for instance by analyzing their movements.

The actuator (10) can be a lock that releases or does not release the access control depending on the control signal (A), for example opens or does not open the door (401). For this purpose, the control signal (A) can be selected depending on the output signal (y) ascertained by the neural network (60) for the input image (x). For example, it is possible that the output signal (y) comprises information that characterizes the identity of an individual detected by the neural network (60), and the control signal (A) is selected based on the identity of the individual.

It is also possible to provide a logical access control instead of the physical access control.

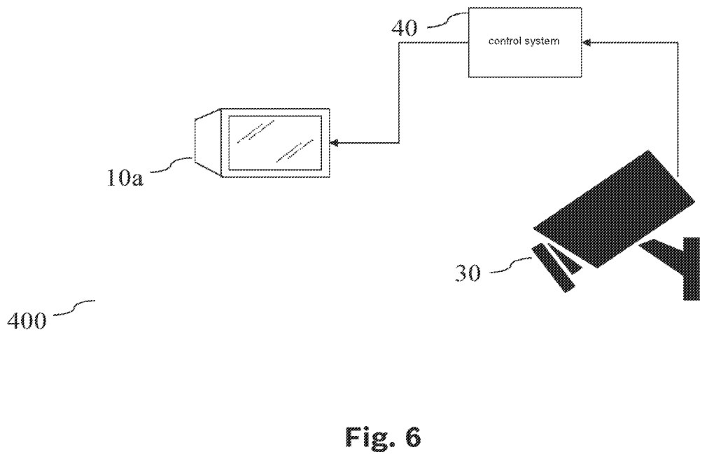

FIG. 6 shows an embodiment example in which the control system (40) is used to control a monitoring system (400). This embodiment example differs from the embodiment example shown in FIG. 5, in that the display unit (10a) that is controlled by the control system 40 is provided instead of the actuator (10). For example, the sensor (30) can record an input image (x) in which at least one individual can be seen, and the position of the at least one individual can be detected by means of the neural network (60). The input image (x) can then be displayed on the display unit (10a) and the detected individuals can be highlighted in color.

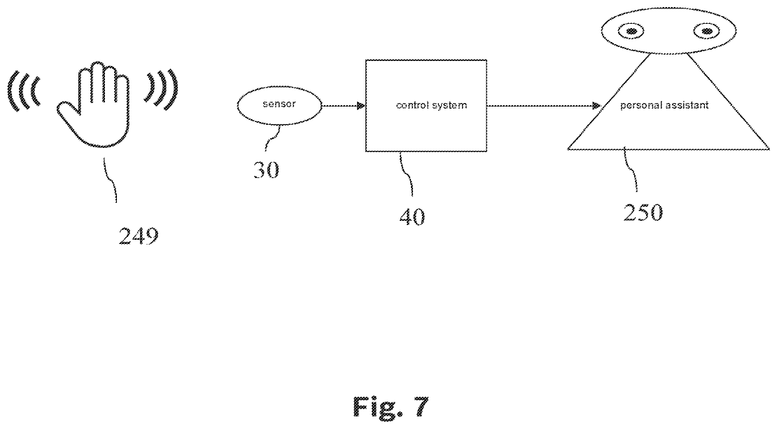

FIG. 7 shows an embodiment example, in which the control system (40) is used to control a personal assistant (250). The sensor (30) is preferably an optical sensor that receives images of a gesture of a user (249), for example a video sensor or a thermal imaging camera.

Depending on the signals of the sensor (30), the control system (40) ascertains a control signal (A) of the personal assistant (250), for example in that the neural network (60) carries out gesture recognition. This ascertained control signal (A) is then transmitted to the personal assistant (250) and said personal assistant is consequently controlled accordingly. The ascertained control signal (A) can in particular be selected such that it corresponds to a presumed desired control by the user (249). This presumed desired control can be ascertained depending on the gesture recognized by the artificial neural network (60). The control system (40) can then select the control signal (A) for transmission to the personal assistant (250) depending on the presumed desired control, and/or select the control signal (A) for transmission to the personal assistant corresponding to the presumed desired control (250).

This corresponding control can include the personal assistant (250) retrieving information from a database, for instance, and reproducing it in such a way that it can be received by the user (249).

It is also possible to provide a household appliance (not shown), in particular a washing machine, a stove, an oven, a microwave or a dishwasher, to be controlled accordingly instead of the personal assistant (250).

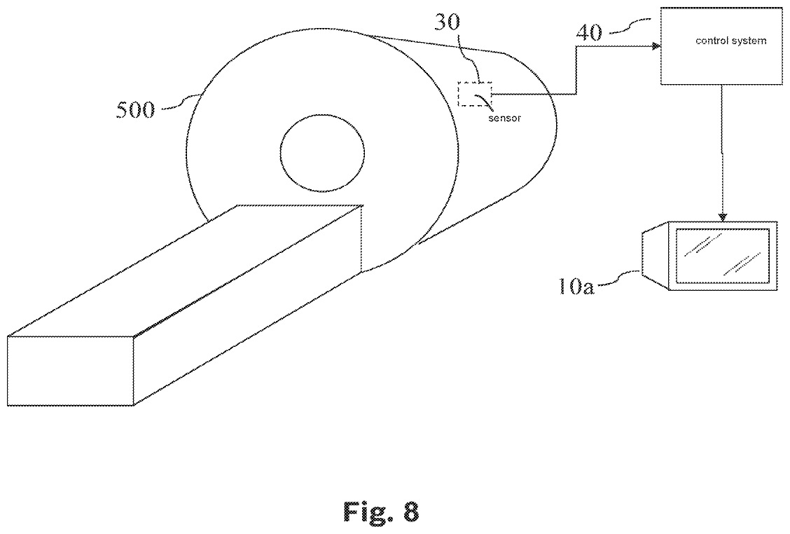

FIG. 8 shows an embodiment example, in which the control system (40) is used to control a medical imaging system (500), for example an MRI, X-ray or ultrasound device. The sensor (30) can be an imaging sensor, for instance. The display unit (10a) is controlled by the control system (40).

The sensor (30) is configured to ascertain an image of a patient, for example an x-ray image, an MRI image or an ultrasound image. At least a portion of the image is transmitted to the neural network (60) as an input signal (x). The neural network (60) can, for instance, be configured to classify different types of tissue that can be seen in the input signal (x), for example in the form of a semantic segmentation.

The control signal (A) can then be selected such that the ascertained types of tissue are highlighted in color on the display unit (10a).

In other embodiment examples (not shown), the imaging system (500) can also be used for non-medical purposes, for example to ascertain material properties of a workpiece. For this purpose, the imaging system (500) can record an image of a workpiece. In this case, the neural network (60) can be configured such that it receives at least a portion of the image as the input signal (x) and classifies it with respect to the material properties of the workpiece. This can be accomplished via a semantic segmentation of the input signal (x), for example. The thus ascertained classification can, for example, be displayed on the display device (10a) together with the input signal (x); the ascertained classification can be displayed as an overlay of the input signal (x), for instance.

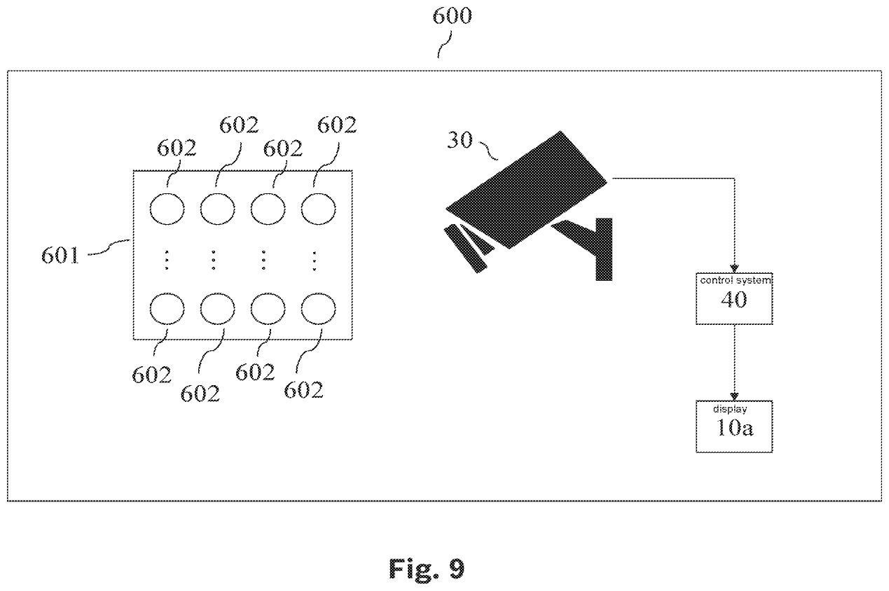

FIG. 9 shows an embodiment example, in which the control system (40) controls a medical analysis device (600). The analysis device (600) is provided with a microarray (601) that comprises a plurality of test fields (602), wherein the test fields have been smeared with a sample. The sample can be a swab from a patient, for example.

The microarray (601) can be a DNA microarray or a protein microarray.

The sensor (30) is configured to record the microarray (601). In particular an optical sensor can be used as the sensor (30), preferably a video sensor.

In this embodiment example, the neural network (60) is configured to determine the result of an analysis of the sample based on an image of the microarray (601). The image classifier can in particular be configured to classify, based on the image, whether the microarray shows the presence of a virus within the sample.

The control signal (A) can then be selected such that the result of the classification is displayed on the display device (10a).

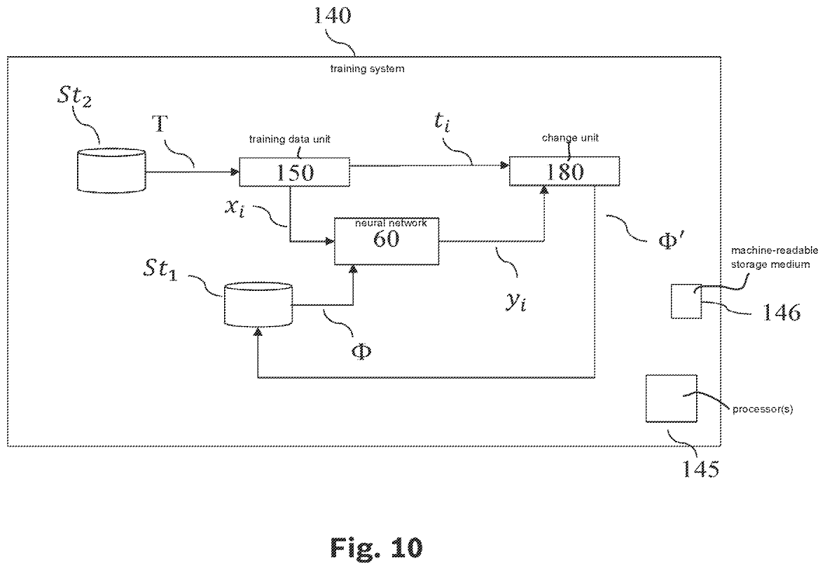

FIG. 10 shows an embodiment example of a training system (140) for training the neural network (60) of the control system (40) using a training data set (T). The training data set (T) comprises a plurality of input signals (xᵢ) which are used to train the neural network (60), wherein, for each input signal (xᵢ), the training data set (T) further comprises a desired output signal (tᵢ) which corresponds to the input signal (xᵢ) and characterizes a classification of the input signal (xᵢ).

For the training, a training data unit (150) accesses a computer-implemented database (St₂), wherein the database (St₂) provides the training data set (T). The training data unit (150) preferably randomly ascertains at least one input signal (xᵢ) and the desired output signal (tᵢ) that corresponds to the input signal (xᵢ) from the training data set (T) and transmits the input signal (xᵢ) to the neural network (60). The neural network (60) ascertains an output signal (yᵢ) based on the input signal (xᵢ).

The desired output signal (tᵢ) and the ascertained output signal (yᵢ) are transmitted to a change unit (180).

Based on the desired output signal (tᵢ) and the ascertained output signal (yᵢ), the change unit (180) then determines new parameters (Φ′) for the classifier (60). For this purpose, the change unit (180) compares the desired output signal (tᵢ) and the ascertained output signal (yᵢ) using a loss function. The loss function ascertains a first loss value that characterizes how far the ascertained output signal (yᵢ) deviates from the desired output signal (tᵢ). In this embodiment example, a negative log-likelihood function is selected as the loss function. In alternative embodiment examples, other loss functions are possible as well.

It is furthermore possible that the ascertained output signal (yᵢ) and the desired output signal (tᵢ) each comprise a plurality of subsignals, for example in the form of tensors, wherein a respective subsignal of the desired output signal (tᵢ) corresponds to a subsignal of the ascertained output signal (yᵢ). It is possible that the neural network (60) is configured for object detection, for example, and a first subsignal characterizes a respective probability of occurrence of an object with respect to a portion of the input signal (xᵢ) and a second subsignal characterizes the exact position of the object. If the ascertained output signal (yᵢ) and the desired output signal (tᵢ) comprise a plurality of corresponding subsignals, a second loss value is preferably ascertained for respective corresponding subsignals using a suitable loss function and the ascertained second loss values are suitably merged to form the first loss value, for example via a weighted sum.

The change unit (180) ascertains the new parameters (Φ′) based on the first loss value. In this embodiment example, this is done using a gradient descent method, preferably stochastic gradient descent, Adam or AdamW. In other embodiment examples, the training can also be based on an evolutionary algorithm or a second-order optimization.

The ascertained new parameters (Φ′) are stored in a model parameter memory (St₁). The ascertained new parameters (Φ′) are preferably made available to the neural network (60) as parameters (Φ).

In other preferred embodiment examples, the described training is iteratively repeated for a predefined number of iteration steps or iteratively repeated until the first loss value falls below a predefined threshold value. Alternatively or additionally, it is also possible that the training is terminated when an average first loss value with respect to a test or validation data set falls below a predefined threshold value. In at least one of the iterations, the new parameters (Φ′) determined in a previous iteration are used as parameters (Φ) of the classifier (60).

The training system (140) can also comprise at least one processor (145) and at least one machine-readable storage medium (146), which includes instructions that, when executed by the processor (145), prompt the training system (140) to carry out a training method according to any one of the aspects of the present invention.

The term “computer” includes any device for processing specifiable calculation rules. These calculation rules can be in the form of software, in the form of hardware or also in a mixed 5 form of software and hardware.

A plurality can be generally be understood as being indexed, i.e., each element of the plurality is allocated a unique index, preferably by allocating consecutive whole numbers to the elements included in the plurality. If a plurality N comprises elements, wherein N is the number of elements in the plurality, the elements are preferably allocated whole numbers from 1 to N.

1-12. (canceled)

13. A computer-implemented neural network, wherein the neural network is configured to ascertain an output signal, wherein the output signal characterizes a classification and/or a regression of an image, wherein, for purposes of ascertaining the output signal, the neural network includes a layer which ascertains an output of the layer based on an input of the layer, wherein the input of the layer is based on the image and the output of the layer is ascertained based on an invariant integration, wherein an invariant function of the invariant integration includes learnable parameters based on which the output of the layer is ascertained.

14. The neural network according to claim 13, wherein the invariant function characterizes a multiplication of at least a portion of the input of the layer by the learnable parameters.

15. The neural network according to claim 14, wherein the invariant function characterizes a weighted sum, wherein weights of summands of the weighted sum characterize the learnable parameters.

16. The neural network according to claim 14, wherein the invariant function characterizes a multilayer perceptron.

17. The neural network according to claim 14, wherein the invariant function characterizes a visual self-attention.

18. The neural network according to claim 13, wherein the input of the layer is ascertained by a first portion of the neural network, wherein the first portion characterizes an equivariant mapping of the image to the input of the layer.

19. A computer-implemented method for ascertaining an output signal, the method comprising the following steps:
providing a computer-implemented neural network, the neural network including a layer which ascertains an output of the layer based on an input of the layer, wherein the input of the layer is based on an image and the output of the layer is ascertained based on an invariant integration, wherein an invariant function of the invariant integration includes learnable parameters based on which the output of the layer is ascertained;
determining, using the neural network and based on the image, an output signal, the output signal characterizing a classification and/or a regression of the image.

20. The method according to claim 19, further comprising ascertaining a control signal of an actuator and/or a display device based on the output signal.

21. A computer-implemented method for training a neural network, the method comprising:
providing a computer-implemented neural network, wherein the neural network is configured to ascertain an output signal, wherein the output signal characterizes a classification and/or a regression of an image, wherein, for purposes of ascertaining the output signal, the neural network includes a layer which ascertains an output of the layer based on an input of the layer, wherein the input of the layer is based on the image and the output of the layer is ascertained based on an invariant integration, wherein an invariant function of the invariant integration includes learnable parameters based on which the output of the layer is ascertained; and
training the neural network.

22. A training device configured for training a neural network, the training device configured to:
provide a computer-implemented neural network, wherein the neural network is configured to ascertain an output signal, wherein the output signal characterizes a classification and/or a regression of an image, wherein, for purposes of ascertaining the output signal, the neural network includes a layer which ascertains an output of the layer based on an input of the layer, wherein the input of the layer is based on the image and the output of the layer is ascertained based on an invariant integration, wherein an invariant function of the invariant integration includes learnable parameters based on which the output of the layer is ascertained; and
train the neural network

23. A non-transitory machine-readable storage medium on which is stored a computer program for training a neural network, the computer program, when executed by a computer, causing the computer to perform the following steps:
providing a computer-implemented neural network, wherein the neural network is configured to ascertain an output signal, wherein the output signal characterizes a classification and/or a regression of an image, wherein, for purposes of ascertaining the output signal, the neural network includes a layer which ascertains an output of the layer based on an input of the layer, wherein the input of the layer is based on the image and the output of the layer is ascertained based on an invariant integration, wherein an invariant function of the invariant integration includes learnable parameters based on which the output of the layer is ascertained; and
training the neural network.
